(19) United States
(12) Patent Application Publication
(10) Pub. No.: US 2015/0067347 A1
(43) Pub. Date: Mar. 5, 2015

(54) SIGNATURE SYSTEM PORTAL FOR SIGNING ELECTRONIC DOCUMENTS

(71) Applicant: COMMUNICATION INTELLIGENCE CORP., Redwood Shores, CA (US)

(72) Inventors: Katherine DEASE, Vestavia Hills, AL (US); Shoaib Aftab MIAN, Dublin, CA (US)

(73) Assignee: COMMUNICATION INTELLIGENCE CORP., Redwood Shores, CA (US)

(21) Appl. No.: 14/538,744

(22) Filed: Nov. 11, 2014

Related U.S. Application Data
(63) Continuation-in-part of application No. PCT/US13/73723, filed on Dec. 6, 2013.
(60) Provisional application No. 62/054,548, filed on Sep. 24, 2014.
(60) Provisional application No. 61/734,254, filed on Dec. 6, 2012.

(51) Int. Cl. G06F 21/64; H04L 9/32

(52) U.S. Cl. CPC G06F 21/645; H04L 9/3247
USPC 713/176

(57) ABSTRACT

An system for operating a portal to provide an electronic document including a signature field to a signer for signature, wherein the signer has a personal electronic device that includes a browser application. Providing the document at a remote server. Providing the device with a web link to the document. Forming a connection between the device and the server via a communications network, responsive to activating of the web link. Accepting the signature of the signer. Communicating the document containing the signature of the signer to the server.

### CROSS-REFERENCE TO RELATED APPLICATIONS

This application claims the benefit of U.S. Provisional Application No. 62/054,548, filed Sep. 24, 2014; this is also a continuation-in-part of International Application No. PCT/US13/73723, filed Dec. 6, 2013, which claims the benefit of U.S. Provisional Application No. 61/734,254, filed Dec. 6, 2012, hereby all incorporated by reference in their entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### COPYRIGHT NOTICE AND PERMISSION

This document contains some material which is subject to copyright protection. The copyright owner has no objection to the reproduction with proper attribution of authorship and ownership and without alteration by anyone of this material as it appears in the files or records of the Patent and Trademark Office, but otherwise reserves all rights whatsoever.

### BACKGROUND OF THE INVENTION

### Technical Field

The present invention relates generally to signing electronic documents, and more particularly to facilitating signing such.

### BACKGROUND ART

A signature serves an evidentiary function, traditionally to give evidence of the provenance of a document and of the intention of an individual with regard to that document. Historically signatures have been a hand applied depiction of someone's name, nickname, or even a simple mark that a person applies to documents as a proof of their identity and intent. In European-based cultures, hand applied signatures have usually been handwritten, or a mechanically applied equivalent that closely resembles a handwritten signature. In other cultures, however, other manners of hand applied signatures have been and continue to be used. Seals impressed in wax or clay, or onto paper or some other medium are examples. These may depict a name, position, or even an abstract symbol.

Of present interest is the act or ceremony of signature, and the parties involved. The writer of a signature is termed a “signatory” or “signer,” with the latter term used herein. In contrast, we herein use the term “agent” for a party seeking a signature or a party assisting a signer.

An example may help to clarify this. Bob wants to purchase an insurance policy and Alice is an employee of an insurance company. Alice provides an insurance contract, a document that will require Bob's signature. This document will also require a signature by Alice or another official of the insurance company. Alice's signature may already exist in the document or can be added later, however, and at this point we are interested only in Bob's signature. Alice may conveniently and simply mail or transmit the document to Bob via facsimile, and he may sign it and mail or fax it back. In this scenario Bob is the signer and Alice is an agent. More typically, for a contract of such significance, Alice and Bob meet, they may discuss various terms in the contract, they may enter data into fields in the contract, and then Bob will apply his signature as Alice watches. Again, Bob is the signer and Alice is an agent.

Continuing with definitions that are used herein, were a document is signed is termed a “signature field.” A single document may have many signature fields. A document may also have “attention points,” such as terms in the example contract above. Bob may have something in the document he wants explained before he signs and Alice may have something in the document she wants to point out to Bob before he signs. Similarly, a document may have “data fields,” for Alice or Bob to enter data before Bob signs. For instance, Alice or Bob may enter a date in a data field. Signature fields, attention points, data fields, and the relationships between them are discussed further in the context of the present invention, below.

Changing tact, today we are starting to make wide use of electronic documents and of electronic signatures in such documents. Unfortunately, the use and acceptance of electronic signatures has proven problematical in some regards.

A first set of electronic signature problems are legal problems. Many of these have been resolved in many jurisdictions. These are not of particular interest here, aside from noting that better solutions to some of the technical problems with electronic signatures will assist in solving remaining legal problems and furthering acceptance in more jurisdictions.

Of present interest is the technology for collecting electronic signatures. A general definition of an electronic signature is “any electronic means that indicates . . . that a person adopts the contents of an electronic document.” References generally discuss three general classes of such electronic means: digitally captured signatures, biometric signatures, and cryptographic signatures.

Electronic Signature or Esignature as defined by the ESIGN Law and UETA means an electronic sound, symbol, or process, attached to or logically associated with a contract or other record and executed or adopted by a person with the intent to sign the record. While any electronic signature can satisfy the ESIGN Lay and UETA's definition of an electronic signature, only digital signatures can satisfy them in a standard capacity, as they follow a set of pre-established industry-based standards.

Digital Signature—The term ‘digital signature’ refers to a sub-set of the electronic signature that includes the digital data to ensure the signer identity, intent, and data integrity of signed documents. Digital signatures are based on standard PM technology that include a SHA-1 hash per signature. Digital signatures are unique per signature and cannot be copied or altered.

Digitally captured signatures particularly include “dynamic signatures,” which are handwritten signatures that are digitized throughout the writing process. Dynamic signatures require a hardware device for signature capture, as well as software able to associate the resulting signature data with the electronic document. To qualify as a digital signature, the signature data is combined into the electronic document and encrypted using hashing (a mathematical process to create a hash value) to allow detection later of any data manipulation (in the electronic signature and/or in the contents of the electronic document).

Some examples of common hardware devices used to collect dynamic signatures are pen pads, special pens, tablets, and other touch screen devices. In the case of specialized devices, such as special pads and pens, the manufacturer typically provides suitable software to operate the device and its presence is transparent to signers using these devices. In the case of general devices, such as tablet PCs and smart phones with touch screens, a manufacturer typically does not provide signature capture software. Instead, the user of such a device usually must procure and install application software (an app) in the device. If the user is an agent, working with many signers, this is arguably manageable. The agent may be downloading an app that is not for a digital signature but simply an esignature. The agent procures the app needed for the type of electronic documents their business entails, installs and configures this app once, learns its use, and then has to be physically present with their device and the signer to collect signatures. In contrast, if a tablet PCs or smart phone owner is a signer and they want to use their own device, they are faced with procuring apps for each type of electronic document they may encounter, then installing (and after a one-time use perhaps uninstalling), configuring, troubleshooting (with potential issues due to conflicting past and present similar apps), learn to use the app, etc. Moreover, especially in this era of malware, many people simply will not install an app unless it is procured from a known and utterly trustworthy party. In fact, many today simply will not install any apps beside those installed initially by the device manufacturer. Additionally, if one is looking for a legally binding digital signature, a downloaded app may not meet the applicable legal requirements.

Today many digitizations of handwritten signatures are taken at a low resolution, and thus are very “two dimensional.” Dynamic signatures in the form of digitizations of seals are not widely used.

Turning next to biometric signatures, in the field of electronic signatures these are considered modern and emerging technology. Biometric characteristics typically considered are fingerprints, hand geometry (finger lengths and palm size), and iris and retinal patterns. Specialized devices are frequently needed to capture such data, although some tablet PCs and smart phones now have sensors that are theoretically capable of capturing some degree of fingerprint, iris, and retinal data. Many of the problems with digitally captured signatures apply as well to biometric signatures. Specialized devices are expensive and lack standardization, but are at least usable by agents who care do to so. The question for such agents, however, is why to bother. An agent has to be physically present with the signature device and the signer, when a simple handwritten signature on paper can be used instead, with scanning or facsimile if desired.

Digressing briefly, it is underappreciated, or at least alternately described in the literature, that hand applied signatures have a long biometric history. For example, signature experts and even many others can readily tell if a signer signed using their right or left hand, or applied a seal using their right or left hand. Handwriting experts will also argue that pen-on-paper signatures contain many dimensions of data. There is the obvious two-dimension pigment pattern in the plane of the page, but also usually present are indications of pen pressure, orientation, stroke speed, etc. Indeed, for important paper documents an ink thumb or palm print may be applied next to a hand applied signature.

Moving on to cryptographic signatures, these are hidden or secret data associated with an electronic signature or document (or both), typically with the signature and cryptographic data combined into the electronic document. Few forms of hand applied signature are a cryptographic signature, so cryptographic signatures serve as a good example here of how electronic signatures can provide advantages over hand applied signatures.

Many other capabilities of modern electronic devices have the potential to provide advantages over hand applied signatures. Many examples are already apparent, while others are emerging. Modern electronic devices can be personal, so that signers can be expected to trust in and be familiar with their own device. Such devices can also be portable or mobile, thus permitting signers to conduct business where they wish, and to an added extent when they wish. Electronic devices can communicate, with people on other devices and with other devices (e.g., servers). For instance, without limitation, automatic device-to-device communication can be of data for accurate time and location, or data for processor intensive operations or archival storage.

Summarizing, electronic signatures have both problems and promise. What is needed is an improved system for electronic signatures. Such an electronic signature system should have as many of the advantages of systems for hand applied signatures, yet such an electronic signature system should also be able to retain and employ as many of the advantages of modern electronic devices as possible.

### BRIEF SUMMARY OF THE INVENTION

Accordingly, it is an object of the present invention to provide a system for signing electronic documents.

Briefly, one preferred embodiment of the present invention is a process for operating a signature system portal to provide an electronic document including a signature field to a signer for signature. The signer has a personal electronic device that includes a browser application, a screen, and an input unit. The electronic document is provided at a remote server and the personal electronic device of the signer is provided with a web link to the electronic document. A connection is formed between the personal electronic device and the remote server via a communications network, responsive to activating of the web link on the personal electronic device with the browser application. The signature of the signer is accepted into the signature field from the input unit of the personal electronic device; and the electronic document containing the signature of the client-signer is communicated to the remote server.

Briefly, another preferred embodiment of the present invention is a computer program, embodied on a non-transitory, tangible computer readable storage medium, to operate a signature system portal to provide an electronic document including a signature field to a signer for signature. The signer has a personal electronic device that includes a browser application, a screen, and an input unit. A code segment provides the electronic document at a remote server. A code segment provides the personal electronic device of the signer with a web link to the electronic document. A code segment forms a connection between the personal electronic device and the remote server via a communications network, responsive to activating the web link on the personal electronic device with the browser application. A code segment accepts the signature of the signer into the signature field from the input unit of the personal electronic device. And a code segment communicates the electronic document containing the signature of the client-signer to the remote server.

And briefly, another preferred embodiment of the present invention is an apparatus for operating a signature system portal to provide an electronic document including a signature field to a signer for signature, wherein the signer has a personal electronic device that includes a browser application, a screen, and an input unit. A server provides an electronic document that is remote from the personal electronic device. A logic activates a web link on the personal electronic device with the browser application to connect the personal electronic device and the remote server via a communications network, responsive to activating of the web link on the personal electronic device with the browser application. A logic presents a signer-side image copy of the electronic document with the signature field on the screen of the personal electronic device. A logic accepts the signature of the signer into the signature field from the input unit of the personal electronic device. And a logic communicates the electronic document containing the signature of the signer to the remote server.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a stylized overview of the inventive signature system being employed;

FIG. 2 shows an agent's view of an electronic document on a terminal;

FIG. 3 shows a signer's view of the screen of an electronic device, which here includes icons to activate a browser and other applications;

FIG. 4 stylistically shows how the agent requests the signer enter into a ceremony to sign the electronic document;

FIG. 5 shows the signer having received a web link in an image copy of the document with a QR code bearing the web link superimposed on the first page of the document;

FIGS. 6a-b respectively show what the signer sees on their electronic device and what the agent sees on their terminal, as a formal signature scenario commences;

FIGS. 7a-c show how the same views of the document are presented to the signer and the agent as the signer browses to a different location in the document;

FIGS. 8a-b show the signer and the agent having co-browsed to the end of the document;

FIG. 9 shows the signer having returned to page one of the document and there activated a first signature field;

FIGS. 10a-b respectively show what the signer sees on his electronic device and what the agent sees on his terminal, as the signer signs the document;

FIG. 11 shows a written signature box (FIG. 10a) having been replaced by a text signature box, into which the signer is entering their signature as text;

FIG. 12 shows how the written signature box reappears and what will be entered as the signature, once the signer operates an enter button;

FIGS. 13a-b respectively show what the signer sees on his electronic device and what the agent sees on his terminal, after the signer has operated the OK button;

FIG. 14 shows the written signature box again, with the signer alternately entering their signature in a manner that may not be aesthetically pleasing;

FIG. 15 is a stylized overview of the inventive signature system being employed, wherein some more detail than FIG. 1 is in some respects, some redundant detail is omitted, and some optional features are introduced;

FIG. 16 is a block diagram showing details of a signature in a document, once applied by the signature system;

FIG. 17 is a screen shot showing a view early in the cycle of a basic document;

FIG. 18 is a screen shot showing a subsequent view in the cycle of the document;

FIG. 19 is a screen shot showing a subsequent view in the cycle of the document, after an agent-signer has completed their signing ceremony;

FIG. 20 is a screen shot showing a subsequent view in the cycle of the document, after the agent-signer has selected a Send Email button;

FIG. 21 is a screen shot showing a subsequent view in the cycle of the document, after the agent-signer has accepted the confirmation dialog and an email has been sent to a client-signer;

FIG. 22 is a screen shot showing the email sent to the client-signer (“John”), including a link for them to commence their signing ceremony;

FIG. 23 shows a subsequent (typically final) view in the cycle of the document, after the client-signer has signed;

And FIG. 24 is a screen shot depicting the signature system portal employing the co-browsing feature of the signature system.

In the various figures of the drawings, like references are used to denote like or similar elements or steps.

### DETAILED DESCRIPTION OF THE INVENTION

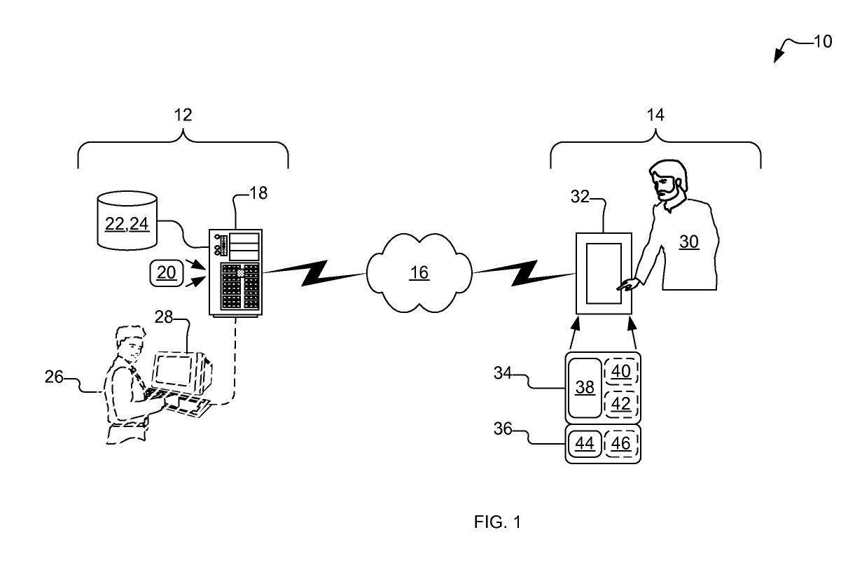

A preferred embodiment of the present invention is a signature system portal for signing electronic documents, as illustrated in the various drawings herein, and particularly in the view of FIG. 1, wherein the embodiment of the invention is depicted by the general reference character 10, 100.

FIG. 1 is a stylized overview of the inventive signature system 10 being employed. Optional elements here are depicted in ghost outline. The signature system 10 is a way of turning any device into a signature capture device. No apps are required and co-browsing is optional and with specific security features.

The signature system 10 has an agent-side 12, a signer-side 14, and a communications network 16 connecting these. The communication network creates two different sessions. Each are connected, but for audit details each device will have its own session and log details. The term “agent” is used in a general sense in this discussion, and not necessarily in accord with the legal definition of an agent or any definition particular to any industry. An agent here can be the originator of the document, or simply a requesting party who assists a signer in executing the document.

The agent-side 12 includes a server 18 that runs a server application 20 and that is able to access at least one electronic document 22. Typically the server 18 and a server application 20 have access to many such documents 22 stored in a database 24. Optionally, an agent 26 with a terminal 28 may be present and may employ the server 18, server application 20, electronic documents 22, and database 24 to interact with the signer-side 14 in real time in a secure connection.

The signer-side 14 includes a signer 30 who has a personal electronic device 32. The personal electronic device 32 may particularly be a mobile type device. The electronic device 32 characteristically has hardware components 34 and software components 36.

The hardware components 34 of the electronic device 32 include those typically necessary in generic personal/mobile electronic devices, and here the electronic device 32 particularly includes a screen 38. The screen 38 is able to display information to the signer 30, and it may also be capable of accepting the input of information from the signer 30 (e.g., the screen 38 may be a touch screen). Optionally, the hardware components 34 may include other output units 40 (e.g., an audio or vibrate output unit). The hardware components 34 may also include other input units 42 (e.g., a microphone or key-pad unit). If the screen 38 is not capable of accepting information from the signer 30, at least one other input unit 42 will be present. The other input units 42 may be optional when the hardware components 34 include a screen 38 capable of accepting information.

The software components 36 include those typically necessary in generic personal/mobile electronic devices (e.g., an operating system), and here the electronic device 32 particularly includes a browser application 44. Optionally, the software components 36 may also include other applications 46 (e.g., an application capable of reading QR codes)) or receiving an email to open the link.

The communications network 16 is straightforward and may be entirely conventional in hardware, albeit using that hardware in a novel way for the present invention. The communication network creates two different secure sessions for each user. Each are connected to each other for a shared session, and for audit details each device has its own session and log details.

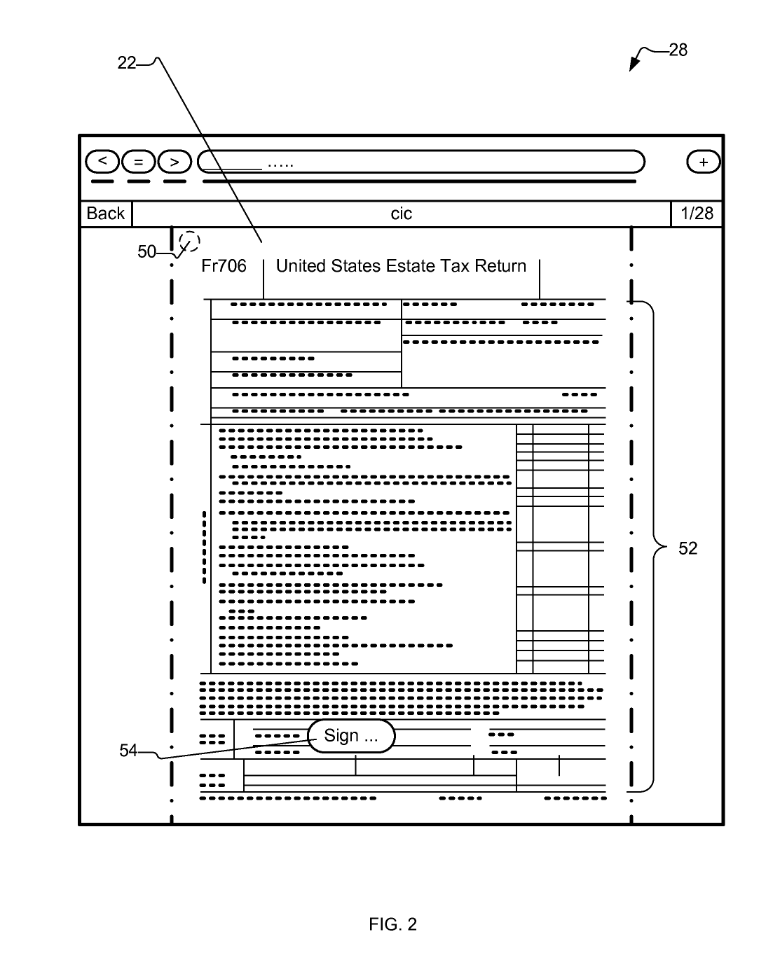

FIGS. 2-14 are views as seen by an agent 26 and a signer 30 as they use the signature system 10 in a now discussed example scenario.

In FIG. 2 the agent 26 is viewing a twenty-eight page electronic document 22 on their terminal 28. For instance the document 22 may be in the widely used Portable Document Format (PDF). The terminal 28 may be any device suitable for use in the manner now described, and thus may be, for example, a conventional personal computer.

Continuing with FIG. 2, shown here in the first page of the document 22 are an attention point 50, many data fields 52, and a signature field 54. Attention points 50 and data fields 52 are optional. In contrast, a document 22 here will typically have at least one signature field 54, since the very point of this signature system 10 is to sign the document 22. Of course, signature fields 54 are optional in documents 22 intended simply for review, at this stage.

An attention point 50 is a location in the document 22 where the attention of a user (agent 26 or signer 30) is directed. The attention point 50 in FIG. 2 is at the very beginning of the document 22 (first page, top, left), thus the view (i.e., the focus) of the user is brought here first. The attention point 50 here is shown in ghost outline to emphasize that it may or may not be visible, as a matter of design choice.

In many respects, attention points 50 can be similar to book markers in a conventional electronic document. However, unlike such markers which a user may not even be aware are present or may simply ignore, an attention point 50 is always navigated to and an affirmative effort must be made to navigate away. Attention points 50 can be navigated through in the manner of following a link or jumping to a particular location in a document. When at a given attention point 50, a next or back operation will (in the manner of following a link or jumping to a different location) navigate within the document 22 to a next or previous attention point 50 or signature field 54.

Data fields 52 are straightforward and may be entirely conventional. Simply put, they are fields were data may, should, or must be entered in an electronic document 22. A data field 52 may or may not be paired with an attention point 50, say, to bring the attention to a data field 52 into which data must be entered.

The underlying mechanisms of signature fields 54 are discussed in detail presently. Conceptually, a signature field 54 operates similar to an attention point 50 with respect to navigation within a document 22. Signature fields 54 can be link-wise or jump-wise navigated through. When at a given signature field 54 a next or back operation will navigate to a next or previous signature field 54 or attention point 50.

As noted, attention points 50 and data fields 52 are optional features of electronic documents 22 used with the inventive signature system 10. If these features are present, a basic embodiment of the signature system 10 need not even detect their presence, yet such an embodiment can still be used for signing the document 22.

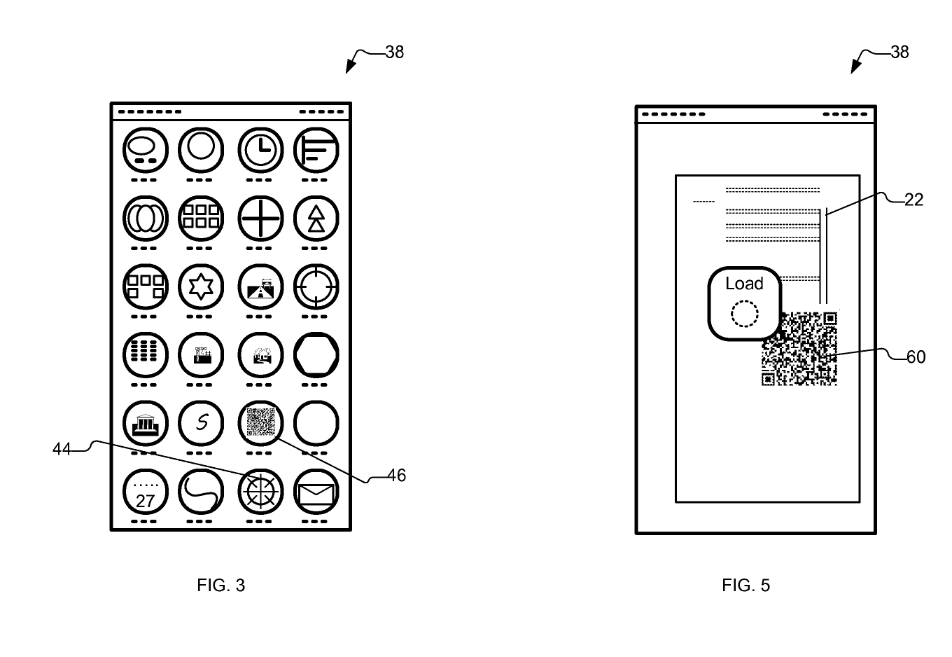

In FIG. 3 the hypothetical signer 30 is viewing the screen 38 of their electronic device 32, which here is showing icons to activate the browser application 44 as well as one particular other application 46 that here is capable of reading Quick Response (QR) codes.

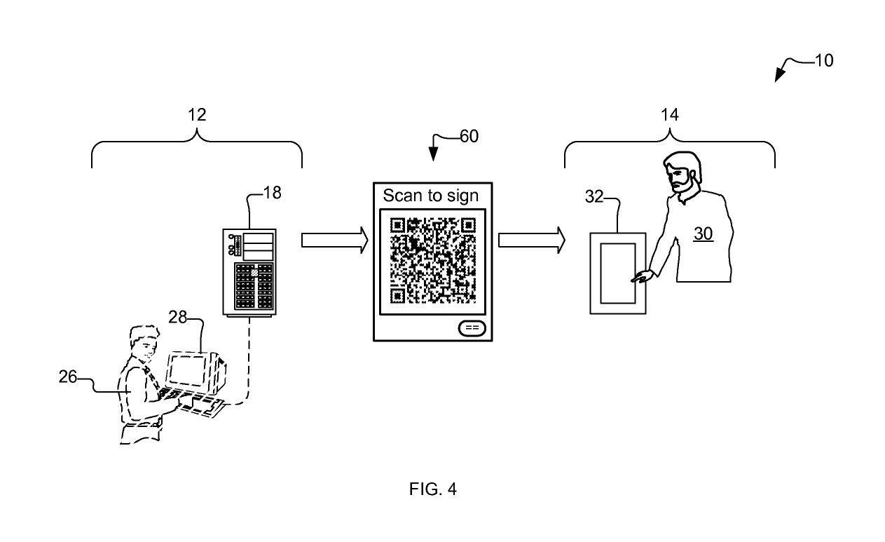

FIG. 4 stylistically shows how the agent 26 requests the signer 30 enter into a ceremony to sign the electronic document 22. The agent 26 provides the signer 30 with a web link 60 to the server application 20. In the example here, the web link 60 is embedded in a QR code, and the manner of delivering the web link 60 can be any that permits the QR code being read by the electronic device 32 of the signer 30. For example, the QR code can be sent electronically as an image or printed on paper, sent via postal mail, and captured into an electronic image. Any manner of providing the web link 60 is usable, and some other mechanisms are discussed presently.

In FIG. 5 the hypothetical signer 30 has received the web link 60, as an image copy of the electronic document 22 with the QR code bearing the web link 60 superimposed on the first page. And the signer 30 is here using the QR code reader other application 46 in their electronic device 32 to read the QR code and operate the web link 60. Depending on the QR code reader application used, or its configuration, employment in their browser application 44 may occur automatically or the signer 30 may have to direct the QR application to pass control to the browser application 44.

Some key points of novelty should be noted here. The signer 30 only needs the electronic device 32, which can easily be their own trusted and familiar electronic device 32. The electronic device 32 needs to have some manner of data input mechanism, but most electronic devices 32 today include one or more suitable such mechanisms. In the example here the data input mechanism is the QR core reader application. An alternate mechanism is a camera and an optical character recognition (OCR) application that is able to read a web link 60 provided as text. Another alternate is a short message service (SMS) application, wherein a button in a message is operated to execute the web link 60. Another alternate is an e-mail application, to receive an e-mail including the web link 60 as a uniform resource locator (URL). Even mere manual keypad entry of a URL type web link 60 as text can be used. Accordingly, the electronic device 32 of the signer 30 can be a smart phone, a tablet type computer, a personal computer (PC), etc.

Similarly, the signer 30 only needs applications that are already, usually even inherently, present in their own trusted and familiar electronic device 32. The browser application 44 needs to be present, but it can be any modern browser able to handle hypertext mark-up language version 5 (HTML5). If the browser application 44 handles SMS messages, no other applications are needed. Alternately or additionally, if one or more other applications 46 are present that can read QR (or other scanned) codes, or that can perform OCR on an image, or that can receive e-mails with URLs, these can be used.

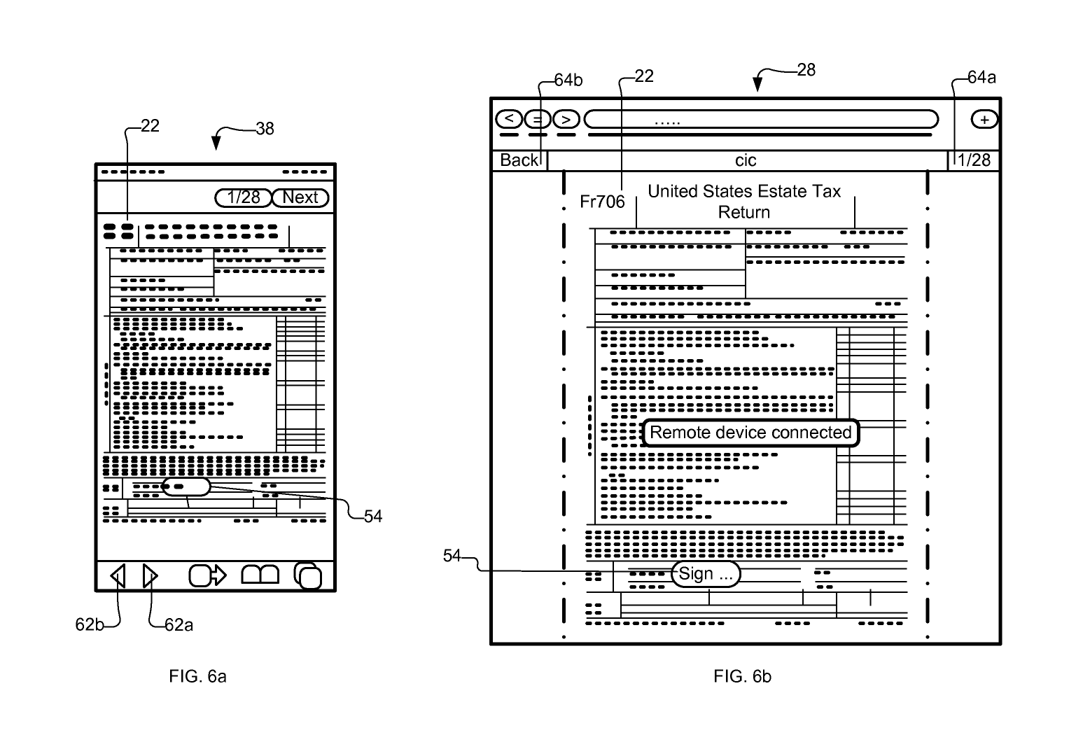

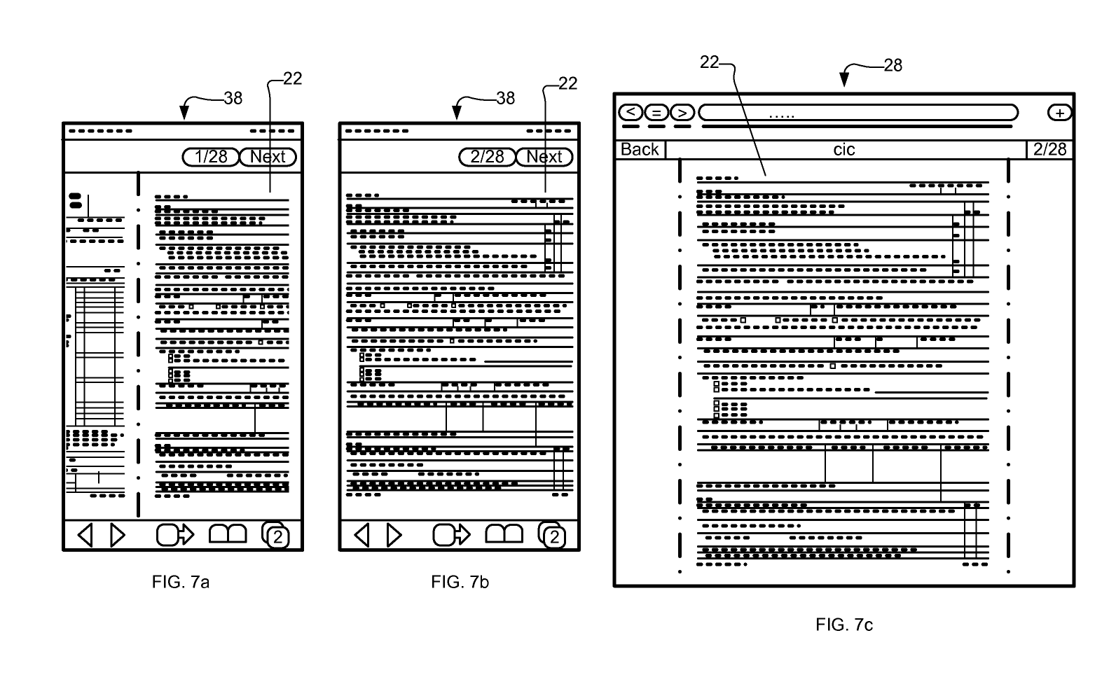

Continuing with the present example, FIGS. 6a-b respectively show what the signer 30 sees on the screen 38 of their electronic device 32 and what the agent 26 sees on their terminal 28. They see the same views of the document 22 and if the signer 30 browses to a different location in the document 22 (FIGS. 7a-b) the agent 26 co-browses to the same location in the document 22 (FIG. 7c). Co-browsing is a very powerful feature of the inventive signature system 10.

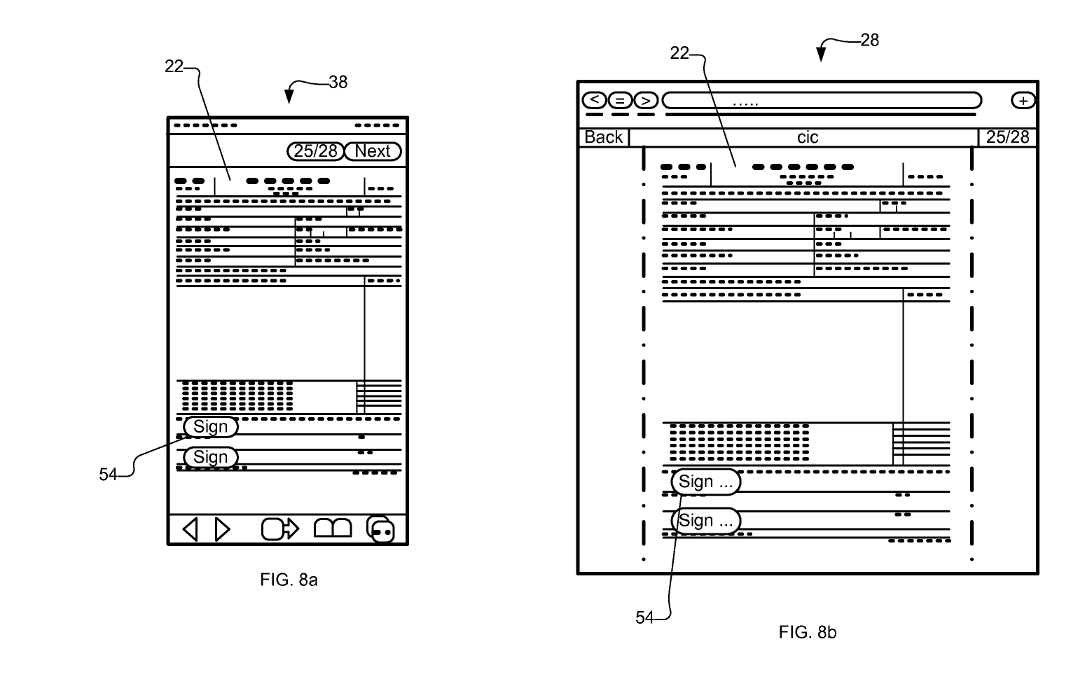

FIG. 6a further shows how the signer 30 has navigation controls 62a-b he can operate to move to a next or previous signature field 54 or attention point 50. And FIG. 6b further shows how the agent 26 similarly has navigation controls 64a-b he can operate to move to a next or previous signature field 54 or attention point 50. The navigation controls 62a-b, 64a-b permit the signer 30 and the agent 26 to browse throughout the document 22, moving forward and backward to important locations as desired. Of course, conventional page controls can also be used to move forward and backward a page at a time, or up and down within a page. If data fields 52 are present, they can be completed or not, as desired. The signer 30 and the agent 26 can handle any questions or comments in real time. Ultimately, the signer 30 and the agent 26 co-browse to the end of the long document 22 (FIGS. 8a-b), and it is time for the signer 30 to formally sign the document 22.

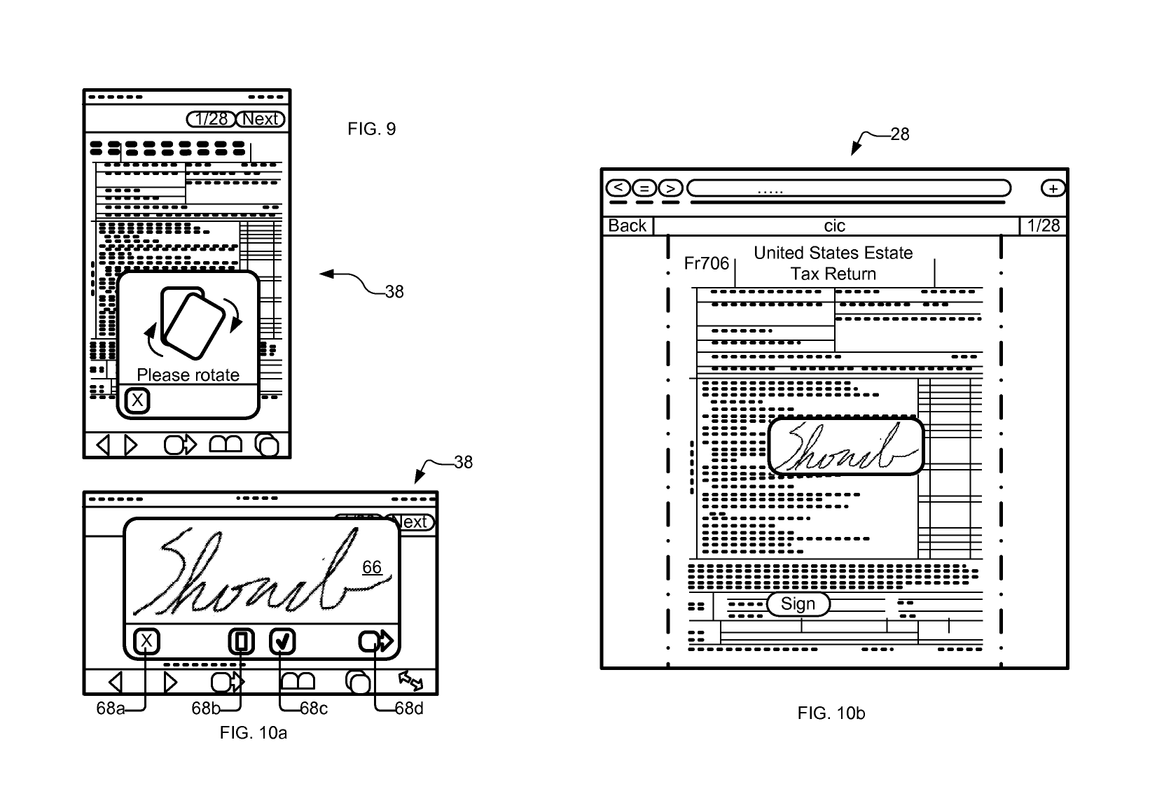

In FIG. 9 the signer 30 has returned to page one of the document 22 and there activated the (first) signature field 54 (the act of activation is straightforward but the manner of activation may vary based on the nature of the electronic device 32, for instance, a screen tap on a signature field 54 can be used if the electronic device has a touch screen). Since the signer 30 here is using an electronic device 32 with a small screen 38, they are instructed to rotate the electronic device 32 from portrait to landscape orientation.

FIGS. 10a-b respectively show what the signer 30 sees on his electronic device 32 and what the agent 26 sees on his terminal 28, as the signer signs the document 22. The signer 30 here has entered his signature in cursive script using the touch screen capability of the screen 38 of this particular electronic device 32.

Continuing with FIG. 10a, the screen 38 shows a written signature box 66 being employed with this embodiment of the signature system 10. This written signature box 66 has a cancel control 68a (“X” button), a start over button 68b (trashcan icon), a text button 68c (pen and paper icon), and an enter button 68d (arrow to right icon). Only the signer 30 has the ability to capture the signature here.

Concurrently, in FIG. 10b, the agent 26 can see the sign button, but that button is not active on the agent session. Only in the client signer session (FIG. 10a) is the sign button active. Likewise, notice that the agent 26 can see the signature capture, but they do not have the buttons to accept, cancel, etc.

For the sake of this example, accept that the signer 30 wants to sign with their device now without using its touch screen. The signer 30 navigates to the last signature field 54 (coincidentally on the last page of the document 22), and activates the (last) signature field 54. Since the signer 30 here is using an electronic device 32 that has a touch screen, the written signature box 66 will typically appear by default. Now the signer 30 can operate the text button 68c. If an electronic device 32 did not have a touch screen, the text signature box described below can be the default.

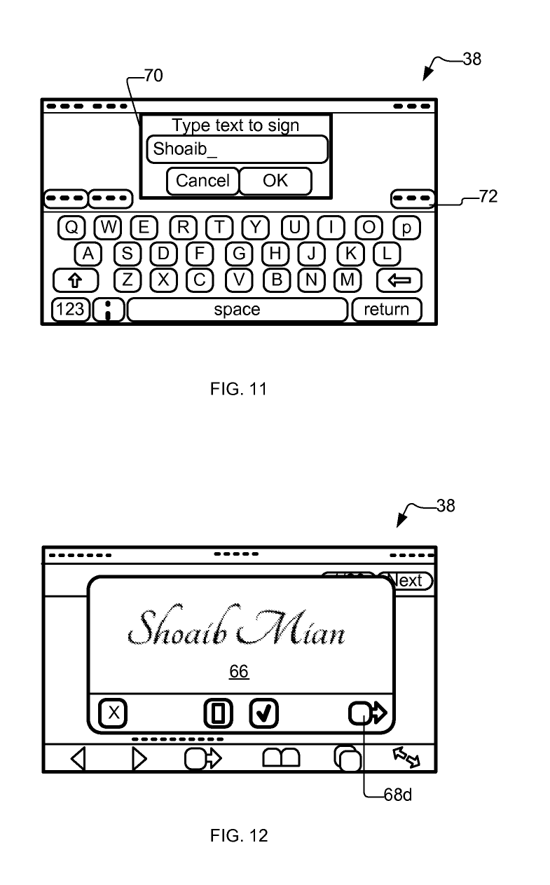

FIG. 11 shows the written signature box 66 replaced by a text signature box 70, into which the signer 30 is entering their signature as text. Once the signer 30 is finished they here operate a done button 72, and FIG. 12 shows how the written signature box 66 now reappears and what will be entered as the signature, once the signer 30 operates the enter button 68d.

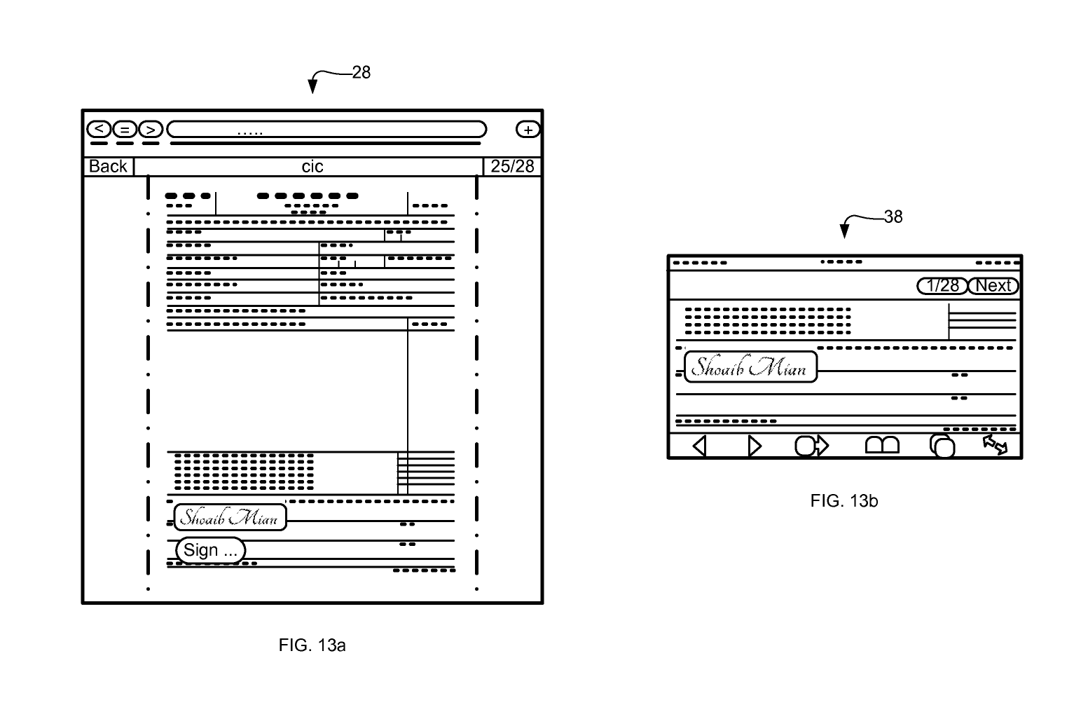

FIGS. 13a-b respectively show what the signer 30 sees on his electronic device 32 and what the agent 26 sees on his terminal 28 after the signer 30 has operated the enter button 68d. At this point the ceremonial act of signing is complete, and copies of the signed document 22 are typically stored on both the agent-side 12 and the signer-side 14, in the server 18, e.g., in the database 24, and in the electronic device 32. Optionally, the agent-side 12 can send a copy of the signed document 22 to the electronic device 32, say, in an e-mail as an attachment. This will facilitate the signer 30 with records keeping.

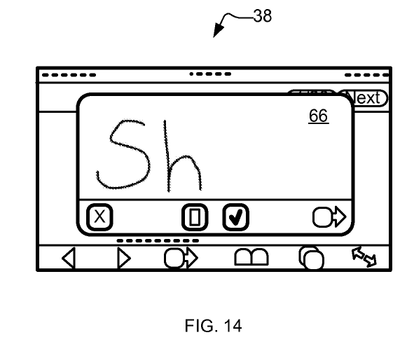

FIG. 14 shows the written signature box 66 again. Here the signer 30 is entering their signature, but it can be seen that the signature may not be aesthetically pleasing. One option to deal with this is to read the signature as entered and to convert it to text, for instance, as the signature appears in FIG. 12. Another option is to smooth the signature as it is entered, for instance, by treating the signature strokes as a series of free form or spline curves and then combining these to reduce the quantity or to otherwise manipulate them to be more visually pleasing.

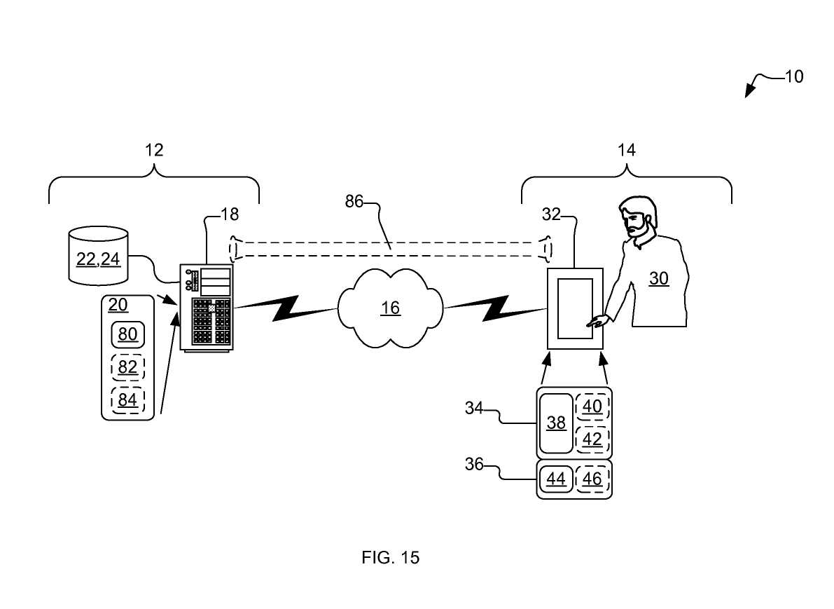

FIG. 15 is a stylized overview of the inventive signature system 10 being employed, in some respects showing more detail than FIG. 1, in some other respects omitting redundant detail, and in some other respects introducing optional features that are now discussed. FIG. 15 shows how the server application 20 running on the server 18 on the agent-side 12 includes a sockets module 80, an optional retry module 82, an optional audit module 84, and how the server application 20 optionally can create a secure channel 86 to the electronic device 32 of the signer 30. Here as well, ghost outline is used to emphasize which elements are optional.

The sockets module 80 employs the WebSockets capability of HTML5 to permit bidirectional communications between the server 18 and the HTML5 (or equivalent) capability of the browser application 44 running in the electronic device 32. The WebSocket specification defines an application programming interface (API) establishing “socket” connections between a browser and a server for full-duplex communications channels over a single transmission control protocol (TCP) socket. Of particular utility here, such a connection is persistent between the client browser and the server and either end can start sending data at any time. In addition, the communications are done over TCP port number 80, which works in those environments that block non-standard Internet connections using a firewall. The WebSocket protocol is currently supported in several browsers including, current versions of Google Chrome™, Internet Explorer™, Firefox™, Safari™, and Opera™. Accordingly, embodiments of the sockets module 80 can permit bidirectional control of the signature system 10 from either the agent-side 12 or the signer-side 14.

Unlike prior art approaches, such as long polling where an HTTP connection to a server is kept open and poor connectivity can undermine completing transactions, the WebSocket protocol permits one approach to implementing the retry module 82, and thus helping to ensure that a signature ceremony is completed entirely in one attempt.

The audit module 84 can record details about transactions, consistent with general best practices for important transactions. In addition, the audit module 84 can also record any other details that are present in transactions conducted with the signature system 10. Particularly when working with the WebSockets capability of the sockets module 80, any action or event that happens on the signer-side 14 during a signing process can be recorded and logged into an audit trail that can be stored (e.g., into the ISID, described below). Thus, for instance, raw and final signatures can be recorded, unlike traditional physical documents where only a final signature appears. As another example, physical documents typically provide little if any information about the speed, pressure of finger, etc. of executing a signature, yet these can be important biometric details when determining the validity of a signature.

Each of the sessions will be recorded in the audit detail showing two unique sessions for each user. This is critically important to show the signor 30 has control over the signing session and not the agent 26.

Implementations of the WebSocket protocol typically use a new URL “ws:” schema for WebSocket connections. One approach to implement the secure channel 86 between the server 18 and the electronic device 32 is to use a new URL “wss:” schema for secure WebSocket connection in the same way that “https:” is used for secure HTTP connections. Alternately, the secure channel 86 can be implemented in the inventive signature system 10 using other approaches.

Changing tact, it can be seen in FIG. 15 that the optional agent 26 and their terminal 28 have been omitted. This is intentional to emphasize that the inventive signature system 10 can handle simpler signature scenarios without these elements being present at all, or that they may be present in the overall environment in which the signature system 10 is used but not be used unless or until advantageous or necessary. For instance, simpler transactions typically will not require an agent 26 to be present in real time to assist a signer 30.

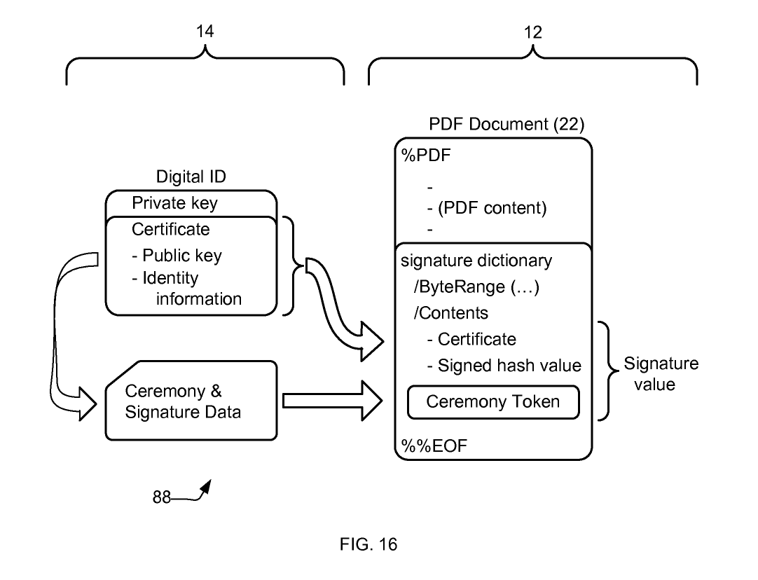

FIG. 16 is a block diagram showing details of a signature in a document 22, once applied by the signature system 10 as the digital signature is applied. Data in the signer-side 14 and the agent-side 12 are shown. In particular, using a certificate (e.g., a public-key infrastructure (PKI) certificate, information and events related to the signature ceremony (e.g., signer, time stamp, IP address, page view, mouse positions, etc.), signature data (gravity prompt, biometric data, etc.), user name, user ID, hardware device, browser type and geo-location are digitally signed and encrypted into a security identifier (SID) which the present inventor calls an ISID (based on the inventors' employer's iSign™). And the ISID is made a part of the document 22.

Up to this point we have primarily discussed a signature system 10 for signing documents 22 from the perspective of a client who is a signer 30, what primarily happens on the signer-side 14, and what an agent 26 and the agent-side 12 do with respect to facilitating this. Let us now consider initial operations by the agent 26 and the agent-side 12 in a signature system portal 100, before and through the signing ceremony and formal signing by the signers 30.

The signature system portal 100 allows agents 26 to select the signature capture method that best meets the specific needs for that transaction. The agents 26 can determine how to collect the signature for each client (i.e., a signer 30) in real time by accessing the web-based signature system portal 100 to permit point of sale document 22 review and signature collection, or the agent 26 can send an email for remote signing from the signature system portal 100 or the agent 26 can initiate a co-browsing session as in FIG. 24. The agent 26 has the ability to use any of the methods implemented for their firm, at any time prior to the completion of the package of documents 22. This flexibility in the signature system portal 100 is a huge asset to agents 26.

With the signature system portal 100 and its flexible signing options, client sales cycles become even faster by offering the ability to match signature methods to the individual situations of each signer 30, whether taking place in person or remotely. All other elements of an e-signature solution can remain unchanged; so, the signing ceremony can remain the same with all the available features like form filling, affirmations, etc. The signature system portal 100 offers the agent 26 the simplicity and flexibility to review documents 22 and to collect the signatures in the manner that best meets the specific needs of each signer 30.

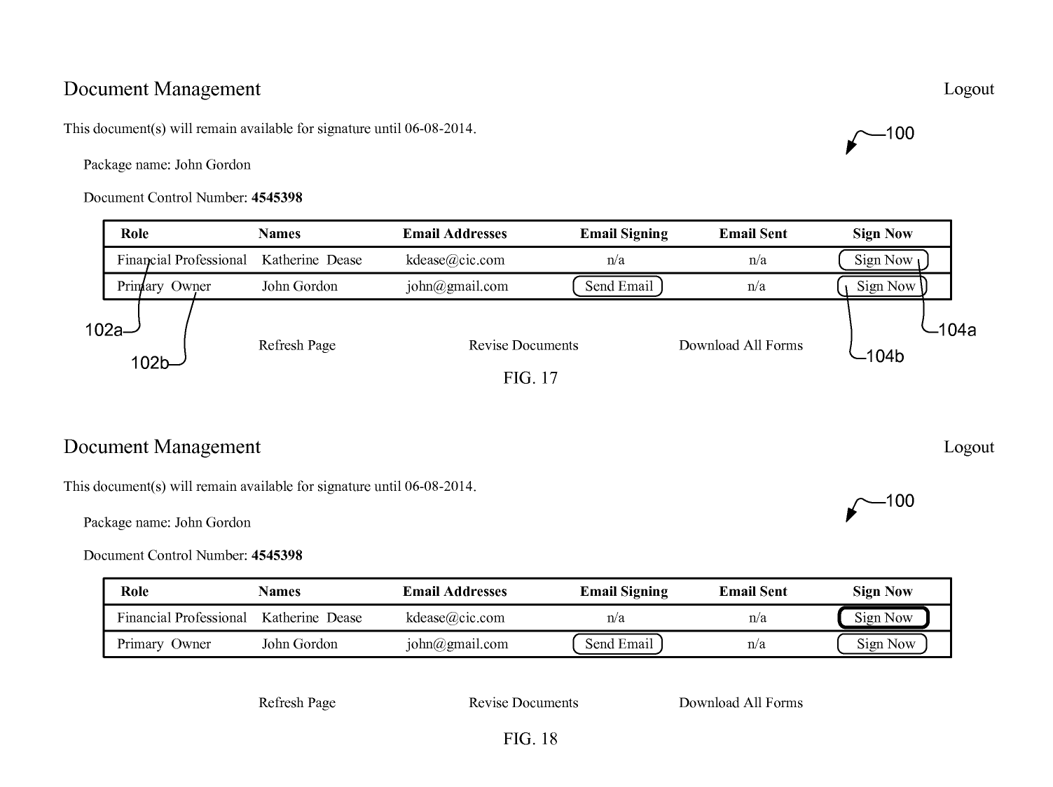

FIGS. 17-23 are screen shots depicting what a agent 26 sees in the signature system portal 100. Using the signature system portal 100, the agent 26 has the control to determine the best signing method for the transaction. They can initiate face to face signing or they can send the link remotely to the signer 30 via email.

FIG. 17 shows a view early in the cycle of a basic document 22. The document 22 has been created and the agent 26 (“Katherine”) and a client (“John”) both need to sign the document 22. For clarity here the agent 26 as a signer 30 is agent-signer 102a and the client as a signer 30 is client-signer 102b. Each signer 30 has a unique link for their signing ceremony. Each link is uniquely built to contain the signing ceremony logic for that signer 30. Each signer 30 can have different authentication requirements, documents to be signed, reviewed, or consented, signing method, etc. The agent-signer 102a is at a terminal so she can directly sign there, and the email signing option for her is automatically not available.

FIG. 18 shows a subsequent view in the cycle of the document 22. The agent-signer 102a has selected a Sign Now button 104a. Upon selecting this button the signing ceremony will be initiated for the agent-signer 102a. A different Sign Now button 104b is available if the client-signer 102b is going to sign locally.

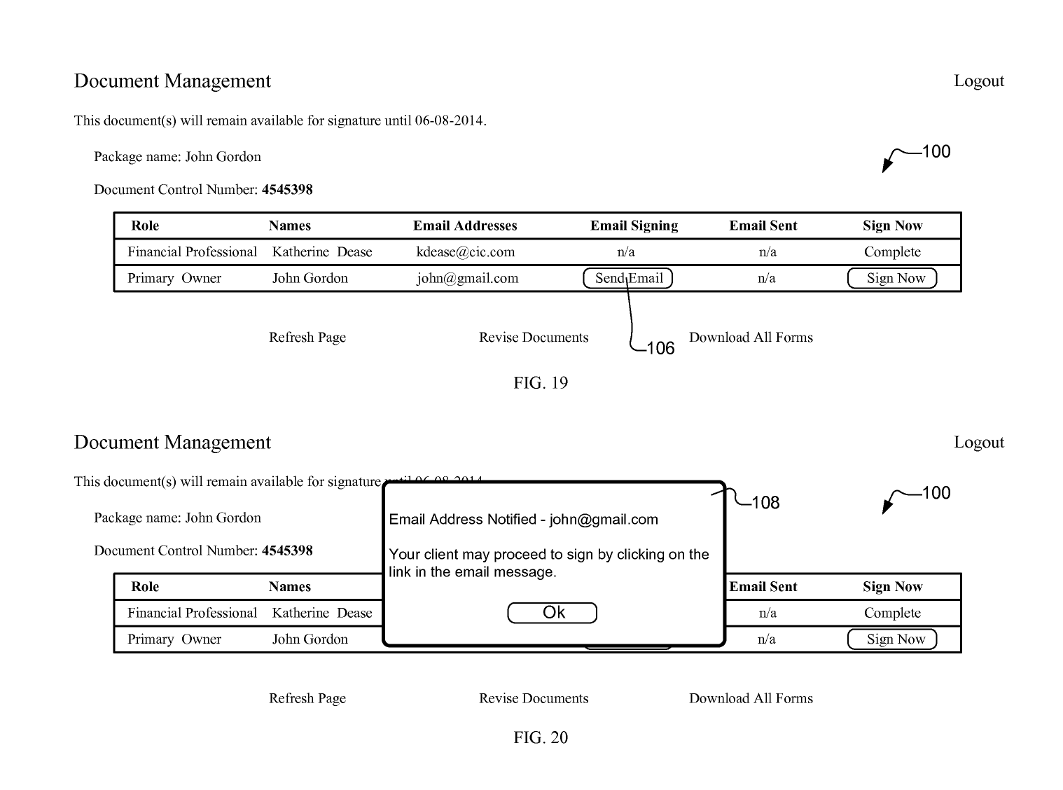

FIG. 19 shows a subsequent view in the cycle of the document 22, after the agent-signer 102a has completed their signing ceremony. As signing by the agent 26 is complete, the signature system portal 100 updates to keep track of the status.

Using the signature system portal 100, signing by the client-signer 102b can be completed in person with the agent 26 or remotely via email. Each signing ceremony is unique so the client-signer 102b can have a different workflow, signing method, and authentication.

FIG. 20 shows a subsequent view in the cycle of the document 22, after the agent-signer 102a has selected a Send Email button 106. A confirmation dialog 108 is presented, and this will trigger the delivery of an email link for the client-signer 102b to sign remotely. The signing ceremony is the same for this signer 30. The difference is just how they get into the signature system 10 (portal or email).

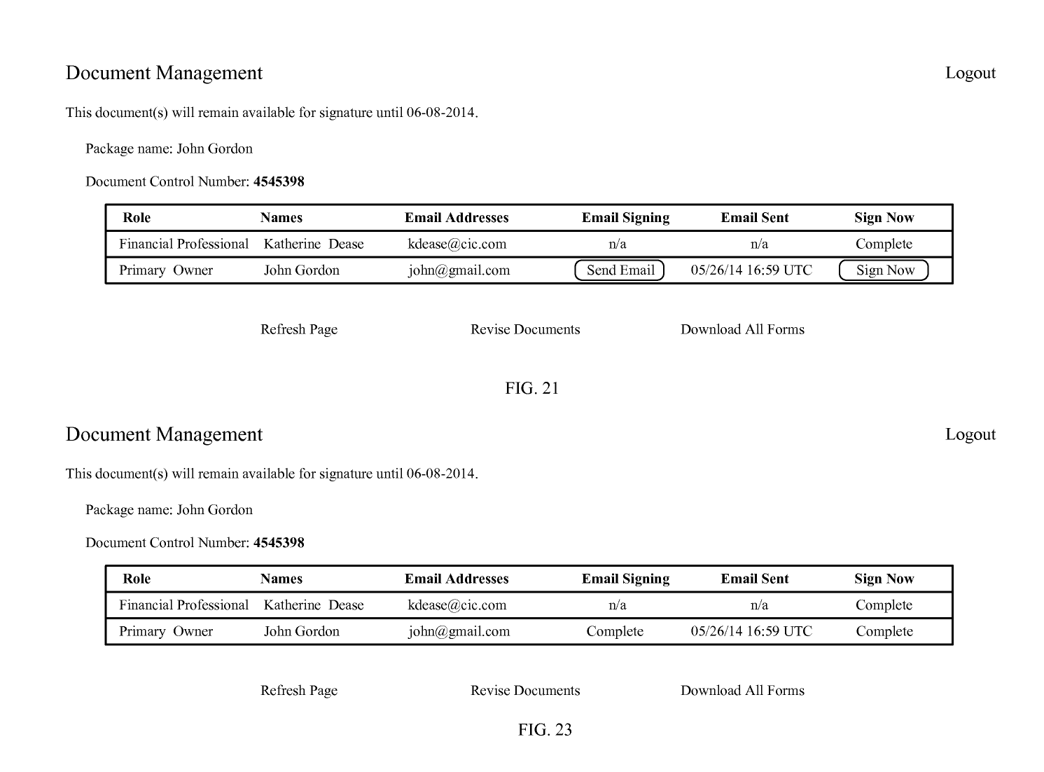

FIG. 21 shows a subsequent view in the cycle of the document 22, after the agent-signer 102a has accepted the confirmation dialog 108 and an email 110 has been sent to the client-signer 102b. Again here, the signature system portal 100 updates to keep track of the status.

The signature system portal 100 can be used on a mobile device; so, agents 26 can gather the point of sale signature sitting with a client or at any location. Additionally, the signature system portal 100 can be used for all use cases such as signing document review and e-delivery.

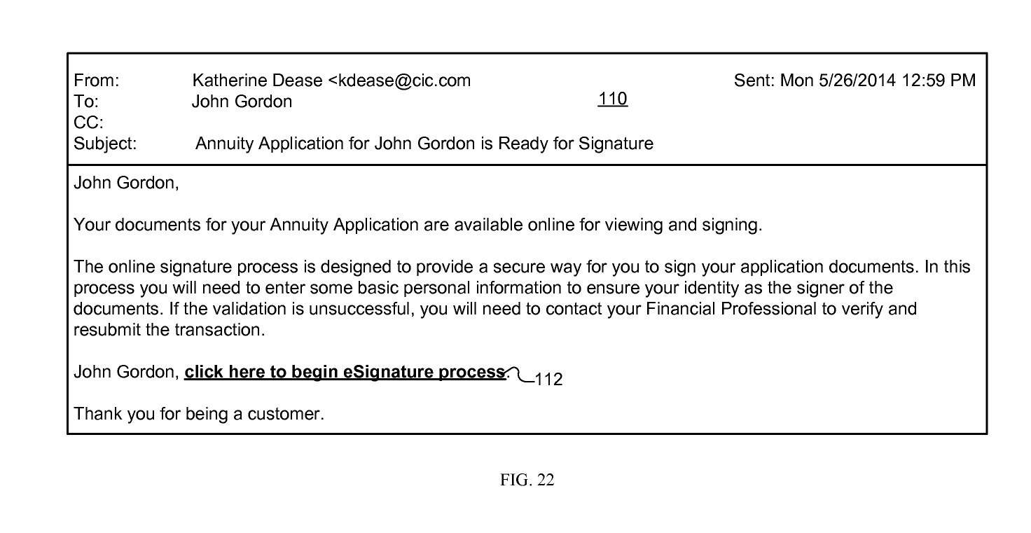

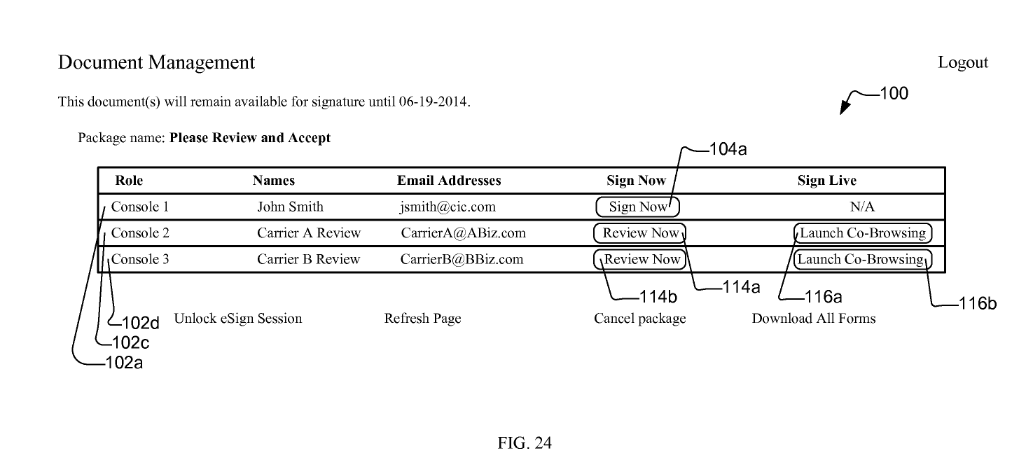

FIG. 22 shows the email 110 sent to the client-signer 102b (“John”), including a link 112 for them to commence their signing ceremony.

FIG. 23 shows a subsequent (typically final) view in the cycle of the document 22, after the client-signer 102b has signed. Again here, the signature system portal 100 updates to keep track of the status.

FIG. 24 is a screen shot depicting the signature system portal 100 employing the co-browsing feature of the signature system 10. Instead of just emailing the link 112 for remote signing, the agent 26 can email a web link 60 that initiates a live session for a remote signer 30. In this case, the agent 26 can see what the signer 30 is seeing and walk the client through a remote signing session.

In FIG. 24 an agent-signer 102a is setting up a package of documents 22 for signatures by staff members of two outside insurance carriers. The agent-signer 102a is at Console 1 and the carriers' staff members are at Console 2 and Console 3 (carrier-signer 102c and carrier-signer 102d). Note, the nature of Console 2 and Console 3 need not be known to the agent-signer 102a and may not yet be decided by the carrier-signer 102c or carrier-signer 102d.

The agent-signer 102a in the signature system portal here has access to Review Now buttons 114a-b for the respective documents 22 for the carrier-signer 102c and carrier-signer 102d (or one complex document requiring the signatures of both). The Review Now buttons 114a-b allow the agent-signer 102a to review the document as well as check on its status with respect to its associated signatory (that is, whether the carrier-signers 102c-d have accessed, partially signed, fully signed, etc. the document 22).

The carrier-signers 102c-d are each associate with one of Launch Co-browsing buttons 116a-b. When the agent-signer 102a operates one of these the respective document 22 is “sent” to the respective carrier-signer 102c-d. That is, the web link 60 is sent (as described for the signature system 10). The document 22 may simply remain on a server of the agent-signer 102a. The carrier-signer 102c, for instance, can then when conveniently operate the web link 60 to initiate the signature ceremony. The agent-signer 102a (or another member of his company) can co-browse as the carrier-signer 102c completes the ceremony, providing assistance if and as needed.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A process for operating a signature system portal to provide an electronic document including a signature field to a signer for signature, wherein the signer has a personal electronic device that includes a browser application, a screen, and an input unit, the process comprising:
providing the electronic document at a remote server;
providing the personal electronic device of the signer with a web link to the electronic document;
forming a connection between the personal electronic device and said remote server via a communications network, responsive to activating of said web link on the personal electronic device with the browser application;
accepting the signature of the signer into said signature field from the input unit of the personal electronic device; and
communicating said electronic document containing the signature of the signer to said remote server.

2. The process of claim 1, wherein said web link includes a code readable by the personal electronic device.

3. The process of claim 2, wherein said code includes a uniform resource locator.

4. The process of claim 2, wherein said code includes a quick response code.

5. The process of claim 1, wherein said connection between the personal electronic device and said remote server via said communications network includes a secure channel.

6. The process of claim 1, wherein the input unit is a touch screen capability of the screen.

7. The process of claim 1, wherein:
an agent-side image copy of said electronic document with said signature field is presented on a terminal of an agent that is remote from the signer on said communications network; and
the process further comprising:
co-browsing within said signor-side image copy and as said agent browses within said agent-side image copy.

8. A computer program, embodied on a non-transitory, tangible computer readable storage medium, to operate a signature system portal to provide an electronic document including a signature field to a signer for signature, wherein the signer has a personal electronic device that includes a browser application, a screen, and an input unit, comprising:
a code segment that provides the electronic document at a remote server;
a code segment that provides the personal electronic device of the signer with a web link to the electronic document;
a code segment that forms a connection between the personal electronic device and said remote server via a communications network, responsive to activating said web link on the personal electronic device with the browser application;
a code segment that accepts the signature of the signer into said signature field from the input unit of the personal electronic device; and
a code segment that communicates said electronic document containing the signature of the client-signer to said remote server.

9. The computer program of claim 10, wherein said code segment that activates said web link reads a code.

10. The computer program of claim 11, wherein said code includes a uniform resource locator.

11. The computer program of claim 11, wherein said code includes quick response code.

12. The computer program of claim 10, wherein said code segment that activates said web link uses a secure channel for said connection between the personal electronic device and said remote server.

13. The computer program of claim 10, wherein:
an agent-side image copy of said electronic document with said signature field is presented on a terminal of an agent that is remote from the signer on said communications network; and
the computer program further comprising:
a code segment that co-browses within said signer-side image copy and as said agent browses within said agent-side image copy.

14. An apparatus for operating a signature system portal to provide an electronic document including a signature field to a signer for signature, wherein the signer has a personal electronic device that includes a browser application, a screen, and an input unit, comprising:
a server provide an electronic document that is remote from the personal electronic device;
logic that activates a web link on said personal electronic device with said browser application to connect said personal electronic device and said remote server via a communications network, responsive to activating of said web link on the personal electronic device with the browser application;
logic that presents a signer-side image copy of the electronic document with the signature field on said screen of said personal electronic device;
logic that accepts the signature of the signer into the signature field from said input unit of said personal electronic device; and
logic that communicates the electronic document containing the signature of the signer to said remote server.

15. The apparatus of claim 19, wherein said personal electronic device is a mobile unit that the signer carries on their person.

16. The apparatus of claim 14, wherein said web link includes a code readable by the personal electronic device.

17. The apparatus of claim 16, wherein said code includes a uniform resource locator.

18. The apparatus of claim 16, wherein said code includes a quick response code.

19. The apparatus of claim 14, wherein said connection between the personal electronic device and said remote server via said communications network includes a secure channel.

20. The apparatus of claim 14, wherein:
an agent-side image copy of said electronic document with said signature field is presented on a terminal of an agent that is remote from the signer on said communications network; and
the apparatus further comprising:
logic that co-browses within said signor-side image copy and as said agent browses within said agent-side image copy.
